(19) United States
(12) Patent Application Publication
(10) Pub. No.: US 2026/0336542 A1
(43) Pub. Date: Oct. 29, 2026

(54) IN-VEHICLE CONTROL DEVICE, CONTROL METHOD, AND CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Toyota Jidosha Kabushiki Kaisha, Toyota-shi, Aichi (JP)

(72) Inventors: Tomohiro OTSU, Yokkaichi-shi, Mie (JP); Hirofumi URAYAMA, Yokkaichi-shi, Mie (JP); Takehiro KAWAUCHI, Yokkaichi-shi, Mie (JP); Shu ISHIZUKA, Toyota-shi, Aichi (JP); Yoshinobu KUROYA, Toyota-shi, Aichi (JP); Kazuya SUGIYAMA, Toyota-shi, Aichi (JP); Daisuke TAKAISHI, Toyota-shi, Aichi (JP); Shingo TOMIDA, Toyota-shi, Aichi (JP); Hiroya ANDOU, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Toyota Jidosha Kabushiki Kaisha, Toyota-Shi, Aichi (JP)

(21) Appl. No.: 19/486,159

(22) PCT Filed: May 30, 2024
(86) PCT No.: PCT/JP2024/019825

§ 371 Date: Nov. 20, 2025

(30) Foreign Application Priority Data
Jun. 1, 2023 (JP) 2023-091042

(51) Int. Cl. B60R 16/023; B60W 50/02; H04W 28/04

(52) U.S. Cl. CPC B60R 16/0232; B60W 50/0205; H04W 28/04

(57) ABSTRACT

An in-vehicle control device connected through a network to an in-vehicle device switchable between an active state and a sleep state includes: an abnormality detection unit configured to detect an abnormality in the in-vehicle device; a determination unit configured to determine whether or not the in-vehicle device is in the sleep state, based on a state of a cluster to which the in-vehicle device belongs; and a control unit configured to, when the in-vehicle device is in the sleep state, disable detection of an abnormality performed by the abnormality detection unit.

### CROSS-REFERENCE TO RELATED APPLICATIONS

This application is the U.S. national stage of PCT/JP2024/019825 filed on May 30, 2024, which claims priority of Japanese Patent Application No. JP 2023-091042 filed on Jun. 1, 2023, the contents of which are incorporated herein.

### TECHNICAL FIELD

The present disclosure relates to an in-vehicle control device, a control method, and a control program.

### BACKGROUND

In a vehicle, various types of in-vehicle devices such as control-related ECUs (Electronic Control units) that control an engine, a transmission, and the like, body-related ECUs that control a headlight, a power window, and the like, and information-related ECUs for a navigation device, a multimedia apparatus, and the like are installed.

Conventionally, in an in-vehicle system in which in-vehicle devices are connected to each other through a network, detecting an abnormality in an in-vehicle device has been performed (e.g., see Japanese Laid-Open Patent Publication No. 2003-276527).

In recent years, a partial network function in which: in an in-vehicle system, in-vehicle devices are divided into clusters, each referred to as a PNC (Partial network Cluster), for respective functions (services), for example; in-vehicle devices in a PNC to be used in execution of a service are woken up; and in-vehicle devices in the other PNCs are caused to sleep, has been developed. The partial network function is standardized in ISO (International Organization for Standardization) 11898-6.

Between ECUs, request information and release information with respect to a PNC are transmitted and received using a network management message (NM message). The NM message includes PN (Partial Network) information indicating the state of request or release with respect to each PNC. In-vehicle devices corresponding to the requested PNC wake up, and in-vehicle devices corresponding to released PNC go to sleep.

In-vehicle devices in a sleep state cannot perform communication. Therefore, an in-vehicle device in the sleep state may be erroneously detected to be abnormal.

### SUMMARY

An in-vehicle control device according to an aspect of the present disclosure is an in-vehicle control device connected through a network to an in-vehicle device switchable between an active state and a sleep state. The in-vehicle control device includes: an abnormality detection unit configured to detect an abnormality in the in-vehicle device; a determination unit configured to determine whether or not the in-vehicle device is in the sleep state, based on a state of a cluster to which the in-vehicle device belongs; and a control unit configured to, when the in-vehicle device is in the sleep state, disable detection of an abnormality performed by the abnormality detection unit.

### Effects of the Present Disclosure

According to the present disclosure, erroneous detection that an in-vehicle device in the sleep state is abnormal can be avoided.

### BRIEF DESCRIPTION OF DRAWINGS

FIG. 1 is a block diagram showing an example of a configuration of an in-vehicle system according to a first embodiment.

FIG. 2 is a block diagram showing an example of a hardware configuration of a relay ECU according to the first embodiment.

FIG. 3 is a block diagram showing an example of a hardware configuration of an ECU according to the first embodiment.

FIG. 4 shows an example of a cluster table.

FIG. 5 shows an example of PN information in an NM message.

FIG. 6 shows an example of transmission of the NM message in the in-vehicle system.

FIG. 7 is a state transition diagram of the ECU.

FIG. 8 is a function block diagram showing an example of the function of the relay ECU according to the first embodiment.

FIG. 9 is a diagram for describing disabling of an abnormality detection function.

FIG. 10 is a flowchart showing an example of an abnormality detection disabling process performed by the relay ECU according to the first embodiment.

FIG. 11 is a flowchart showing an example of an abnormality detection enabling process performed by the relay ECU according to the first embodiment.

FIG. 12 is a sequence diagram showing a first example of the procedure of disabling of abnormality detection in the in-vehicle system according to the first embodiment.

FIG. 13 is a sequence diagram showing a second example of the procedure of disabling of abnormality detection in the in-vehicle system according to the first embodiment.

FIG. 14 is a block diagram showing an example of a configuration of an in-vehicle system according to a second embodiment.

### DETAILED DESCRIPTION OF PREFERRED EMBODIMENTS

Hereinafter, the outlines of embodiments of the present disclosure are listed and described.

In a first aspect, an in-vehicle control device according to the present embodiment is an in-vehicle control device connected through a network to an in-vehicle device switchable between an active state and a sleep state. The in-vehicle control device includes: an abnormality detection unit configured to detect an abnormality in the in-vehicle device; a determination unit configured to determine whether or not the in-vehicle device is in the sleep state, based on a state of a cluster to which the in-vehicle device belongs; and a control unit configured to, when the in-vehicle device is in the sleep state, disable detection of an abnormality performed by the abnormality detection unit. Accordingly, erroneous detection that an in-vehicle device in the sleep state is abnormal can be avoided.

In a second aspect according to the first aspect, when the in-vehicle control device belongs to the cluster, the determination unit may determine whether or not the in-vehicle device is in the sleep state, based on the state of the cluster retained by the in-vehicle control device. Accordingly, when the in-vehicle control device belongs to the same cluster as that of the in-vehicle device, whether the in-vehicle device is in the active state or in the sleep state can be determined.

In a third aspect according to the first aspect, when the in-vehicle control device does not belong to the cluster, the determination unit may determine whether or not the in-vehicle device is in the sleep state, based on the state of the cluster designated in a control message transmitted through the network in order to control the cluster. Accordingly, when the in-vehicle control device does not belong to the same cluster as that of the in-vehicle device, whether the in-vehicle device is in the active state or in the sleep state can be determined.

In a fourth aspect according to any one of the first to the third aspects, when the in-vehicle device belongs to a first cluster and a second cluster, the determination unit may determine whether or not the in-vehicle device is in the sleep state, based on a state of the first cluster and a state of the second cluster. Accordingly, when the in-vehicle device belongs to the first cluster and the second cluster, whether the in-vehicle device is in the active state or in the sleep state can be determined.

In a fifth aspect according to any one of the first to the fourth aspects, the determination unit may identify a cluster to which the in-vehicle device belongs, based on a table indicating a correspondence relationship between a cluster and an in-vehicle device, and may determine whether or not the in-vehicle device is in the sleep state, based on a state of the cluster having been identified. Accordingly, based on the table, which cluster the in-vehicle device belongs to can be identified in a simple manner.

In a sixth aspect according to any one of the first to the fifth aspects, the state of the cluster may include an operating state and a stopped state, and when the state of the cluster is the stopped state, the determination unit may determine that the in-vehicle device is in the sleep state. Accordingly, based on the state of the cluster, it is possible to accurately determine that the in-vehicle device is in the sleep state.

In a seventh aspect according to any one of the first to the sixth aspects, the abnormality detection unit may detect an abnormality in the in-vehicle device, based on a communication state of the in-vehicle device through the network. Accordingly, when the in-vehicle device is in the sleep state, it is possible to avoid erroneous detection of an abnormality in the in-vehicle device based on the communication state, by disabling the abnormality detection unit.

In an eighth aspect according to any one of the first to the seventh aspects, when the in-vehicle control device belongs to the cluster and the cluster is in the stopped state, the in-vehicle control device may maintain an active state. Accordingly, a situation where an abnormality in the in-vehicle device cannot be detected due to the in-vehicle control device entering a sleep state, can be avoided.

In a ninth aspect, a control method according to the present embodiment is a control method to be used by an in-vehicle control device connected through a network to an in-vehicle device switchable between an active state and a sleep state. The control method includes: a step of determining whether or not the in-vehicle device is in the sleep state, based on a state of a cluster to which the in-vehicle device belongs; and a step of disabling an abnormality detection function of detecting an abnormality in the in-vehicle device, when the in-vehicle device is in the sleep state. Accordingly, erroneous detection that an in-vehicle device in the sleep state is abnormal can be avoided.

In a tenth aspect, a control program according to the present embodiment is a control program to be executed by an in-vehicle control device connected through a network to an in-vehicle device switchable between an active state and a sleep state. The control program causes a computer to execute: a step of determining whether or not the in-vehicle device is in the sleep state, based on a state of a cluster to which the in-vehicle device belongs; and a step of disabling an abnormality detection function of detecting an abnormality in the in-vehicle device, when the in-vehicle device is in the sleep state. Accordingly, erroneous detection that an in-vehicle device in the sleep state is abnormal can be avoided.

The present disclosure can be realized not only as an in-vehicle control device including the characteristic configuration as described above, a control method having steps of the characteristic processes performed in the in-vehicle control device, and a control program for causing the in-vehicle control device to execute the characteristic processes, but also as an in-vehicle system including the in-vehicle control device, and a part or the entirety of the in-vehicle control device can be realized as a semiconductor integrated circuit.

Hereinafter, with reference to the drawings, details of embodiments of the present invention will be described. At least some parts of the embodiments described below may be combined as desired.

### First Embodiment

### 1-1. In-Vehicle System

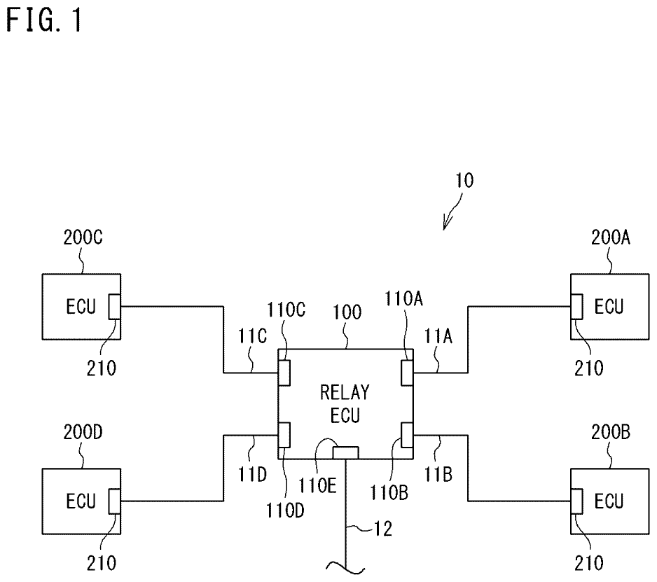

FIG. 1 is a block diagram showing an example of a configuration of an in-vehicle system according to the first embodiment. An in-vehicle system 10 is installed in a vehicle.

The in-vehicle system 10 according to the first embodiment includes a relay ECU 100 and ECUs 200A, 200B, 200C, 200D. The in-vehicle system 10 is an in-vehicle network composed of the relay ECU 100, the ECUs 200A, 200B, 200C, 200D, . . . , and communication lines 11A, 11B, 11C, 11D, 12 connecting them. In the description below, the communication lines 11A, 11B, 11C, 11D may be collectively referred to as “communication line 11”.

The plurality of ECUs 200A, 200B, 200C, 200D are disposed in components of the vehicle. The ECUs 200A, 200B, 200C, 200D individually control the hardware of components of the vehicle and monitor the state of the hardware of components of the vehicle. For example, the ECUs 200A, 200B, 200C, 200D are control-related, body-related, or information-related ECUs. In the description below, the ECUs 200A, 200B, 200C, 200D may to as “ECU 200”.

The relay ECU 100 is connected to each of the ECUs 200A, 200B, 200C, 200D and the communication lines 11A, 11B, 11C, 11D. That is, the relay ECU 100 and the ECU 200A are connected to each other by the communication line 11A. The relay ECU 100 and the ECU 200B are connected to each other by the communication line 11B. The relay ECU 100 and the ECU 200C are connected to each other by the communication line 11C. The relay ECU 100 and the ECU 200D are connected to each other by the communication line 11D.

From the relay ECU 100, the communication line 12 extends. The relay ECU 100 is connected to an in-vehicle device (e.g., a relay ECU or an ECU) (not shown) through the communication line 12.

Each of the communication lines 11A, 11B, 11C, 11D, 12 is an Ethernet cable (“Ethernet” is a registered trademark). Each of the relay ECU 100 and the ECUs 200A, 200B, 200C, 200D has a communication function according to Ethernet.

The relay ECU 100 relays communication between the ECUs 200A, 200B, 200C, 200D (and another ECU). That is, the relay ECU 100 relays an Ethernet frame (message) between the ECUs 200A, 200B, 200C, 200D. For example, the relay ECU 100 functions as at least one Ethernet switch of a layer 2 switch and a layer 3 switch. Thus, the ECUs 200A, 200B, 200C, 200D can communicate with each other.

The ECUs 200A, 200B, 200C, 200D respectively include communication I/Fs 210 connected to the communication lines 11A, 11B, 11C, 11D. The communication I/Fs 210 are each an I/F compatible with the partial network function. The relay ECU 100 includes a communication I/F 110A connected to the communication line 11A, a communication I/F 110B connected to the communication line 11B, a communication I/F 110C connected to the communication line 11C, a communication I/F 110D connected to the communication line 11D, and a communication I/F 110E connected to the communication line 12. The communication I/Fs 110A, 110B, 110C, 110D are each an I/F compatible with the partial network function.

The relay ECU 100 and the ECUs 200A, 200B, 200C, 200D use a communication protocol compatible with the partial network function. In the first embodiment, the communication protocol is Ethernet.

The relay ECU 100 and the ECUs 200A, 200B, 200C, 200D can transmit and receive an NM message for a partial network. The NM message is a message that designates “requested” or “released” for each PNC. The NM message is a UDP (User Datagram Protocol) packet that is periodically transmitted. Each ECU 200 (node) belonging to a PNC for which “requested” is designated in the NM message wakes up. Each node belonging to a PNC for which “released” is designated in the NM message goes to sleep. Here, “sleep” means that the ECU 200 temporarily stops functions except for some functions and stands by in a power-saving state. “Wake up” means that the ECU 200 in a sleep state transitions to an active state. “Active state” means that all functions of the ECU 200 operate.

### 1-2. Configuration of Relay ECU

In the following, a hardware configuration of the relay ECU 100 will be described. The relay ECU 100 is an example of “in-vehicle control device”.

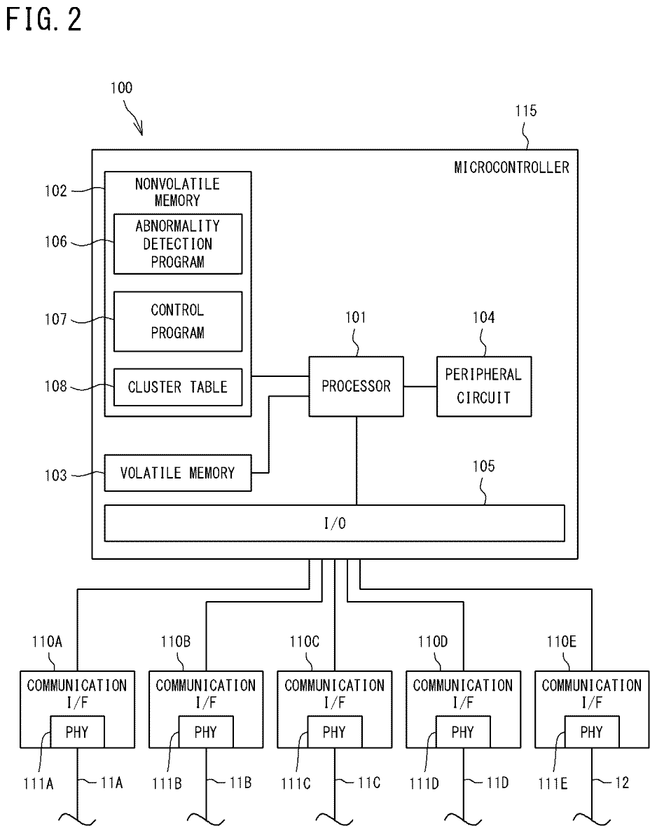

FIG. 2 is a block diagram showing an example of a hardware configuration of the relay ECU according to the first embodiment. The relay ECU 100 includes a microcontroller 115 and the communication I/Fs 110A, 110B, 110C, 110D.

The microcontroller 115 is a single-chip semiconductor integrated circuit, for example, and includes a processor 101, a nonvolatile memory 102, a volatile memory 103, a peripheral circuit 104, and an input/output interface (I/O) 105.

The volatile memory 103 is a semiconductor memory such as an SRAM (Static Random Access Memory) or a DRAM (Dynamic Random Access Memory), for example. The nonvolatile memory 102 is a semiconductor memory such as a flash memory, a ROM (Read Only Memory), an EPROM (Erasable Programmable Read Only Memory), or an EEPROM (Electrically Erasable Programmable Read-Only Memory), for example.

The processor 101 is a CPU (Central Processing Unit), for example. However, the processor 101 is not limited to a CPU. The processor 101 may be a GPU (Graphics Processing Unit). The processor 101 is configured to be able to execute computer programs. However, the processor 101 may include an ASIC (Application Specific Integrated Circuit) in a part thereof, or may include a programmable logic device such as an FPGA (Field Programmable Gate Array) in a part thereof, for example.

In the nonvolatile memory 102, an abnormality detection program 106, a control program 107, which are computer programs, and data used in execution of each of the abnormality detection program 106 and the control program 107 are stored. The abnormality detection program 106 and the control program 107 can be stored in a storage medium such as a flash memory, a ROM, or a CD-ROM. Based on the abnormality detection program 106, the processor 101 can detect an abnormality that has occurred in the ECU 200. Based on the control program 107, the processor 101 can avoid erroneous detection of an abnormality performed by the abnormality detection program 106.

In the nonvolatile memory 102, a cluster table 108 is stored. The cluster table 108 will be described later.

The peripheral circuit 104 is a circuit for causing the microcontroller 115 to realize various functions. For example, the peripheral circuit 104 includes circuits for a general-purpose input/output port (GPIO), an analog/digital converter, a timer, serial communication, and the like. The serial communication circuit conforms to a standard such as UART (Universal Asynchronous Receiver/Transmitter), I2C (Inter-Integrated Circuit), or SPI (serial peripheral interface), for example.

The I/O 105 is connected to the communication I/Fs 110A, 110B, 110C, 110D. The I/O 105 is a port used for performing input/output with respect to the communication I/Fs 110A, 110B, 110C, 110D.

The communication I/Fs 110A, 110B, 110C, 110D are each a communication interface conforming to Ethernet. As described above, the communication I/Fs 110A, 110B, 110C, 110D are each an I/F compatible with the partial network function.

The communication I/F 110A includes a PHY 111A. The communication I/F 110B includes a PHY 111B. The communication I/F 110C includes a PHY 111C. The communication I/F 110D includes a PHY 111D.

The PHY 111A is connected to the communication line 11A. The PHY 111B is connected to the communication line 11B. The PHY 111C is connected to the communication line 11C. The PHY 111D is connected to the communication line 11D.

The PHY 111A, 111B, 111C, 111D converts an analog signal received from the communication line 11A, 11B, 11C, 11D to a digital signal. The PHY 111A, 111B, 111C, 111D converts a digital signal to an analog signal and sends out the converted analog signal to the communication line 11A, 11B, 11C, 11D.

The PHY 111A, 111B, 111C, 111D is compatible with the partial network function, and can interpret a PNC designated as a wake-up target and a PNC designated as a sleep target in the NM message.

The communication I/F 110A, 110B, 110C, 110D includes a processing circuit (not shown) for executing processing of a frame (message) that is transmitted and received.

### 1-3. Configuration of ECU

In the following, a hardware configuration of the ECU 200 will be described. The ECU 200 is an example of “in-vehicle device”.

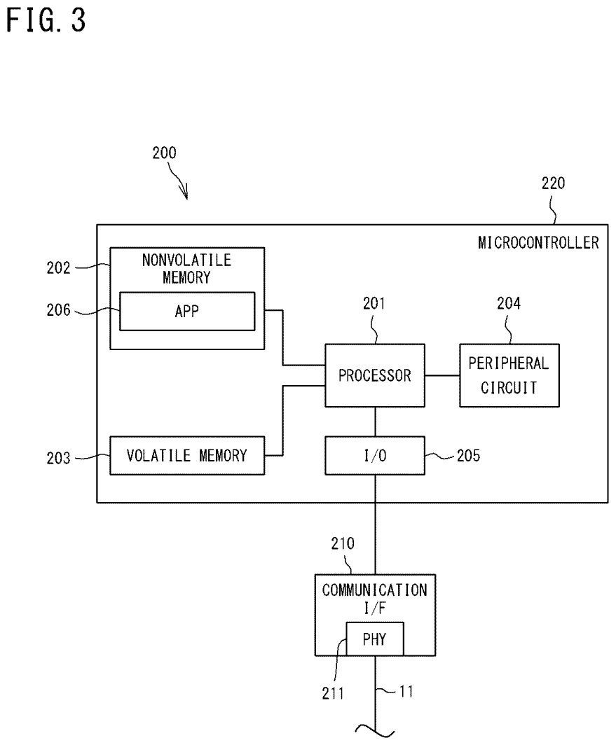

FIG. 3 is a block diagram showing an example of a hardware configuration of the ECU according to the first embodiment. The ECU 200 includes a microcontroller 220 and a communication I/F 210.

The microcontroller 220 has the same configuration as that of the microcontroller 115 of the relay ECU 100 described above. That is, the microcontroller 220 includes a processor 201, a nonvolatile memory 202, a volatile memory 203, a peripheral circuit 204, and an I/O 205.

In the nonvolatile memory 202, an application program (hereinafter, also referred to as “APP”) 206, which is a computer program, and data used in execution of the APP 206 are stored. The APP 206 can be stored in a storage medium such as a flash memory, a ROM, or a CD-ROM. Based on the APP 206, the processor 201 can execute a function for providing a service as an ECU.

The peripheral circuit 204 includes a serial communication circuit conforming to a standard such as UART, I2C, or SPI, for example. The serial communication circuit of the peripheral circuit 204 is connected to a device or a sensor serving as a control target of the ECU 200, and can receive a signal outputted from the sensor or transmit a control signal to the control target.

The I/O 205 is connected to the communication I/F 210. The I/O 205 is a port used for performing input/output with respect to the communication I/F 210.

The communication I/F 210 is a communication interface conforming to Ethernet. As described above, the communication I/F 210 is an I/F compatible with the partial network function.

The communication I/F 210 includes a PHY 211.

The PHY 211 is connected to the communication line 11. That is, the PHY 211 of the ECU 200A is connected to the communication line 11A. The PHY 211 of the ECU 200B is connected to the communication line 11B. The PHY 211 of the ECU 200C is connected to the communication line 11C. The PHY 211 of the ECU 200D is connected to the communication line 11D.

The PHY 211 converts an analog signal received from the communication line 11 to a digital signal. The PHY 211 converts a digital signal to an analog signal, and sends out the converted analog signal to the communication line 11.

The communication I/F 210 includes a processing circuit (not shown) for executing processing of a frame (message) that is transmitted and received.

The communication I/F 210 is compatible with the partial network function. The above-described processing circuit or the processor 201 can interpret a PNC designated as a wake-up target and a PNC designated as a sleep target in the NM message.

### 1-4. PNC

The PNC will be described. Each of the relay ECU 100 and the ECUs 200A, 200B, 200C, 200D (and another ECU) belongs to at least one PNC. The nonvolatile memory 102 of the relay ECU 100 stores therein the cluster table 108 in which the relay ECU 100 and the ECUs 200A, 200B, 200C, 200D, and the PNC to which each of the relay ECU 100 and the ECUs 200A, 200B, 200C, 200D belongs are associated with each other (see FIG. 2).

The PNC may be set for each service to be provided to a user, for example. The service is executed by one or a plurality of ECUs.

Examples of the service executed by a plurality of ECU include auto high beam control of headlights, auto cruise traveling, door unlocking, air conditioner remote control, theft prevention alarm notification, charging of a battery for traveling (high-voltage battery) in an electric vehicle, and charging of an auxiliary battery (low-voltage battery) from the battery for traveling.

The auto high beam control of headlights is executed by a headlight ECU that controls headlights and vehicle-traveling ECUs (engine ECU, brake ECU, etc.). Therefore, the headlight ECU and the vehicle-traveling ECUs belong to the same PNC.

The auto cruise traveling is executed by an ADAS (Advanced Driver-Assistance Systems) ECU, a radar ECU that processes detection results from a radar to detect an object outside the vehicle, and the vehicle-traveling ECUs. Therefore, the ADAS ECU, the radar ECU, and the vehicle-traveling ECUs belong to the same PNC.

The door unlocking is executed by a body ECU that controls movable parts (door lock, power window, door mirror, etc.) of the body of the vehicle, and an authentication ECU that authenticates a code transmitted from a smart key (key fob), for example. Therefore, the body ECU and the authentication ECU belong to the same PNC.

The air conditioner remote control is executed by an air conditioner ECU that controls an air conditioner, and an engine ECU that controls the engine, for example. Therefore, the air conditioner ECU and the engine ECU belong to the same PNC.

The theft prevention alarm notification is executed by an alarm ECU that emits an alarm, and an external communication ECU that communicates with an external device (e.g., a server of a security company), for example. Therefore, the alarm ECU and the external communication ECU belong to the same PNC.

The charging of the battery for traveling is executed by a charging ECU that controls charging of the battery for traveling and the auxiliary battery, and a battery management ECU that manages the battery for traveling, for example. Therefore, the charging ECU and the battery management ECU belong to the same PNC.

The charging of the auxiliary battery is executed by the charging ECU, the battery management ECU, and a power conversion ECU that controls a DC/DC converter that converts a direct-current voltage outputted from the battery for traveling. Therefore, the charging ECU, the battery management ECU, and the power conversion ECU belong to the same PNC.

There is also a service that is executed by a single ECU. Therefore, it is also possible to set a PNC that includes one ECU only. Examples of the service executed by a single ECU include wiper drive, automatic adjustment of steering, and automatic adjustment of a seat.

The wiper drive is executed by a wiper ECU that controls a wiper. Therefore, only the wiper ECU belongs to one PNC.

The automatic adjustment of steering is executed by a power-steering ECU that controls power steering. Therefore, only the power-steering ECU belongs to one PNC.

The automatic adjustment of a seat is executed by a seat ECU that controls a power seat. Therefore, only the seat ECU belongs to one PNC.

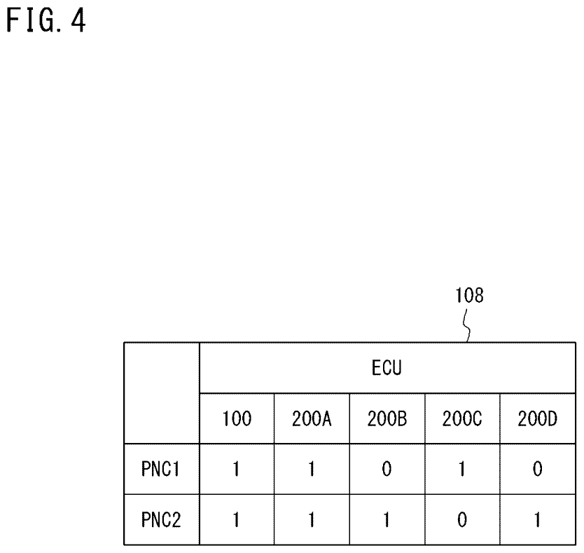

FIG. 4 shows an example of the cluster table. The cluster table 108 shown in FIG. 4 indicates which ECU among the relay ECU 100 and the ECUs 200A, 200B, 200C, 200D belongs to the two PNCs, i.e., PNC 1 and PNC 2. The number of PNCs in FIG. 4 is an example, and three or more PNCs may be prepared, or a single PNC may be prepared. In the table, “1” indicates that, to the PNC in the row of “1”, the corresponding ECU among the relay ECU 100 and the ECUs 200A, 200B, 200C, 200D belongs, and “0” indicates that, to the PNC in the row of “0”, the corresponding ECU among the relay ECU 100 and the ECUs 200A, 200B, 200C, 200D does not belong.

For example, the relay ECU 100 and the ECU 200A, 200C belong to the PNC 1. The relay ECU 100 and the ECU 200A, 200B, 200D belong to the PNC 2.

The cluster table 108 is static information stored in advance in the nonvolatile memory 102. However, the cluster table 108 may be dynamically created based on the NM message relayed by the relay ECU 100, for example.

### 1-5. State of ECU

The state of the ECU 200 includes an active state and a sleep state. The active state is a state where the ECU 200 is active, and is a state where the ECU 200 controls the control target and can communicate with the relay ECU 100 and another ECU 200. The sleep state is a state where the ECU 200 is stopped except for some functions of the communication I/F 210.

The NM message includes PN information. The PN information includes designation of “Requested” or “Released” for each PNC. “Requested” corresponds to waking-up of the PNC. That is, the PNC for which “requested” is designated in the NM message is the PNC serving as a wake-up target. “Released” corresponds to sleep of the PNC. That is, the PNC for which “released” is designated in the NM message is the PNC serving as a sleep target.

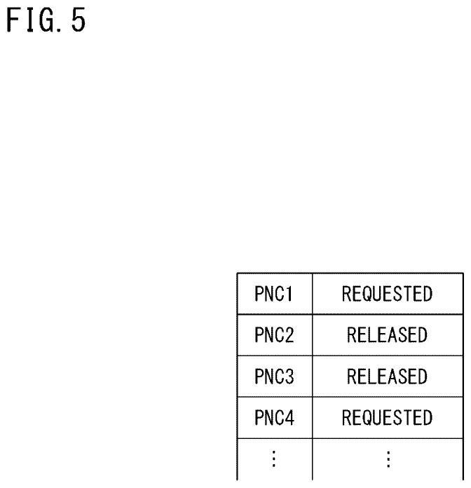

FIG. 5 shows an example of the PN information in the NM message. In the example in FIG. 5, “requested” is designated for the PNC 1, “released” is designated for the PNC 2, “released” is designated for a PNC 3, and “requested” is designated for a PNC 4. That is, the ECU 200 belonging to the PNC 1 is the wake-up target, the ECU 200 belonging to the PNC 2 is the sleep target, the ECU 200 belonging to the PNC 3 is the sleep target, and the ECU 200 belonging to the PNC 4 is the wake-up target.

The ECU 200 that is the transmission source of an NM message broadcasts the NM message. Accordingly, the NM message is transmitted to all ECUs 200 connected to the network. However, the NM message may be unicast or multicast to the transmission target ECU 200.

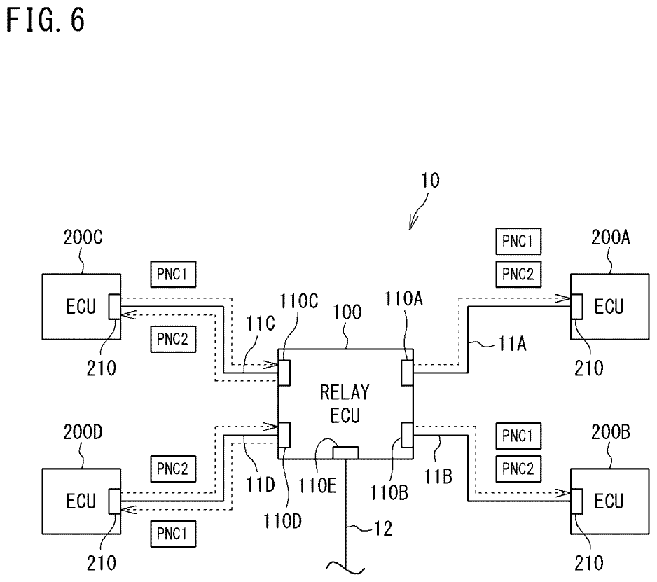

FIG. 6 shows an example of transmission of the NM message in the in-vehicle system. In FIG. 6, the quadrangular frame surrounding the characters “PNC 1” indicates an NM message in which “requested” is designated for the PNC 1. The quadrangular frame surrounding the characters “PNC 2” indicates an NM message in which “requested” is designated for the PNC 2.

The ECU 200C transmits an NM message (hereinafter, also referred to as “first message”) in which “requested” is designated for the PNC 1. Upon receiving the first message, the relay ECU 100 sends out the first message from each port. Accordingly, the first message is transmitted to the ECUs 200A, 200B, 200D. Here, a case where the NM message is broadcast is described. In a case where the NM message is unicast or multicast, the first message is sent out only from the port connected to the ECU 200A belonging to the PNC 1.

The ECU 200D transmits an NM message (hereinafter, also referred to as “second message”) in which “requested” is designated for the PNC 2. Upon receiving the second message, the relay ECU 100 sends out the second message from each port. Accordingly, the second message is transmitted to the ECUs 200A, 200B, 200C. In a case where the NM message is unicast or multicast, the second message is sent out only from the ports that are respectively connected to the ECU 200A and the ECU 200B that belong to the PNC 2.

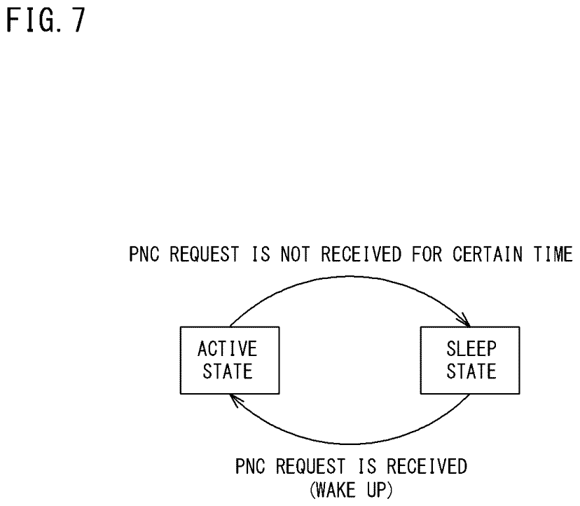

FIG. 7 is a state transition diagram of the ECU. The ECU 200 in the sleep state can receive an NM message. That is, the communication I/F 210 of the ECU 200 has a function of receiving an NM message even in the sleep state. Upon receiving an NM message, the communication I/F 210 refers to the PN information included in the NM message, and determines whether or not “requested” (wake up) is designated for the PNC to which the ECU 200 belongs.

When “requested” is designated for the PNC in the NM message, the ECU 200 wakes up. Accordingly, the state of the ECU 200 transitions from the sleep state to the active state.

When the ECU 200 in the active state has received an NM message in which “requested” is designated for the PNC to which the own device belongs, the ECU 200 maintains the active state.

When the ECU 200 in the active state has not received, for a certain period, an NM message in which “requested” is designated for the PNC to which the own device belongs, the ECU 200 transitions from the active state to the sleep state. That is, when the ECU 200 in the active state has received, for a certain period, only an NM message in which “released” is designated for the PNC to which the own device belongs, or when the ECU 200 in the active state has not received any NM message, the ECU 200 transitions from the active state to the sleep state.

With reference back to FIG. 6, it is assumed that the ECUs 200A and 200B are in the sleep state. The ECUs 200C, 200D which are the transmission source of an NM message are in the active state. The relay ECU 100 which relays the NM message is also in the active state.

As shown in FIG. 4, it is assumed that the relay ECU 100 and the ECUs 200A, 200C belong to the PNC 1, and the relay ECU 100 and the ECUs 200A, 200B, 200D belong to the PNC 2.

When the ECU 200A has received the first message in which “requested” is designated for the PNC 1, the ECU 200A wakes up. Accordingly, the state of the ECU 200A transitions from the sleep state to the active state. When having received the first message, the ECU 200A determines that the state of the PNC 1 is “operating state”, and retains (e.g., stores into the nonvolatile memory 202) information indicating that the PNC 1 is in the operating state. Here, the ECU 200A also retains information indicating that the PNC 2 is in a stopped state.

Meanwhile, the ECU 200B not belonging to the PNC 1 maintains the sleep state even if the ECU 200B has received the first message.

When having received the second message in which “requested” is designated for the PNC 2, the ECU 200A maintains the active state since the ECU 200A is already in the active state. When having received the second message, the ECU 200A determines that the state of the PNC 2 is “operating state”, and retains information indicating that the PNC 2 is in the operating state. That is, the ECU 200A rewrites the information stored, for example, in the nonvolatile memory 202, and indicating that the PNC 2 is in the stopped state, into information indicating that the PNC 2 is in the operating state.

Meanwhile, when the ECU 200B belonging to the PNC 2 has received the second message, the ECU 200B wakes up. Accordingly, the state of the ECU 200B transitions from the sleep state to the active state. When having received the second message, the ECU 200B determines that the state of the PNC 2 is in “operating state”, and retains information indicating that the PNC 2 is in the operating state.

For example, when the ECU 200C no longer transmits the first message, the ECU 200A measures, using a built-in timer, the elapsed time from when the first message has no longer been received, and determines whether or not the measured elapsed time has reached a certain period. When the first message has not been received for a certain period, the ECU 200A determines that the PNC 1 is in the stopped state, and retains information indicating that the PNC 1 is in the stopped state. That is, the ECU 200A rewrites the information stored, for example, in the nonvolatile memory 202 and indicating that the PNC 1 is in the operating state, into information indicating that the PNC 1 is in the stopped state.

Meanwhile, the ECU 200B not belonging to the PNC 1 maintains the active state even if the ECU 200B does not receive the first message for a certain period.

When the ECU 200D no longer transmits the second message, the ECU 200A measures, using a built-in timer, the elapsed time from when the second message has no longer been received, and determines whether or not the measured elapsed time has reached a certain period. When the second message has not been received for a certain period, the ECU 200A determines that the PNC 2 is in the stopped state, and retains information indicating that the PNC 2 is in the stopped state. That is, the ECU 200A rewrites the information stored, for example, in the nonvolatile memory 202 and indicating that the PNC 2 is in the operating state, into information indicating that the PNC 2 is in the stopped state.

Since both the PNC 1 and the PNC 2 to which the ECU 200A belong have entered the stopped state, the ECU 200A goes to sleep.

The ECU 200B measures, using a built-in timer, the elapsed time from when the second message has no longer been received, and determines whether or not the measured elapsed time has reached a certain period. When the second message has not been received for a certain period, the ECU 200B determines that the PNC 2 is in the stopped state and retains information indicating that the PNC 2 is in the stopped state.

Since the PNC to which the ECU 200B belongs is only the PNC 2 and the PNC 2 has entered the stopped state, the ECU 200B goes to sleep.

### 1-6. Function of Relay ECU

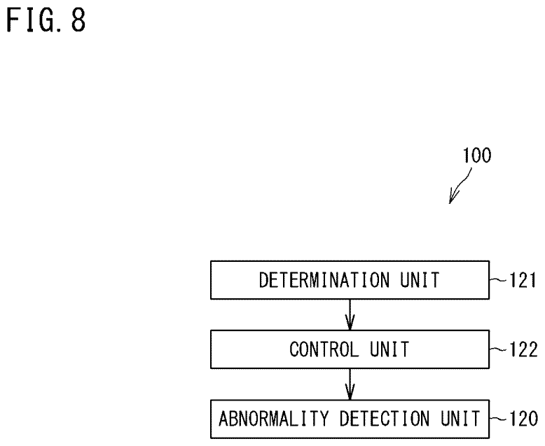

FIG. 8 is a function block diagram showing an example of the function of the relay ECU according to the first embodiment.

The relay ECU 100 has functions of an abnormality detection unit 120, a determination unit 121, and a control unit 122. The abnormality detection unit 120 is realized by the processor 101 executing the abnormality detection program 106. The determination unit 121 and the control unit 122 are realized by the processor 101 executing the control program 107.

The abnormality detection unit 120 detects an abnormality in the ECU 200. For example, the abnormality detection unit 120 detects an abnormality in the ECU 200, based on the communication state of the ECU 200 through a network.

In a specific example, the abnormality detection unit 120 monitors the link state of each of the communication I/Fs 110A, 110B, 110C, 110D. The abnormality detection unit 120 determines that the ECU 200 corresponding to a communication I/F in a link-up state among the communication I/Fs 110A, 110B, 110C, 110D, is normal. The abnormality detection unit 120 detects a communication I/F that has entered a link-down state among the communication I/Fs 110A, 110B, 110C, 110D, thereby detecting an abnormality in the ECU 200 corresponding to this communication I/F. For example, when the communication I/F 110A is in the link-down state, the abnormality detection unit 120 detects an abnormality in the ECU 200A.

In another example, the abnormality detection unit 120 sends out a specific message (hereinafter, also referred to as “abnormality detection message”) from each of the communication I/Fs 110A, 110B, 110C, 110D. Upon receiving the abnormality detection message, each ECU 200 returns a response message (Ack). When having received the Ack, the abnormality detection unit 120 determines that the ECU 200 corresponding to the port (communication I/F) that has received the Ack is normal. The abnormality detection unit 120 detects a communication I/F that has not received the Ack among the communication I/Fs 110A, 110B, 110C, 110D, thereby detecting an abnormality in the ECU 200 corresponding to this communication I/F. For example, when the communication I/F 110A does not receive the Ack, the abnormality detection unit 120 detects an abnormality in the ECU 200A.

The above abnormality detection message may be an echo request according to ICMP (Internet Control Message Protocol), and the response message may be an echo reply.

Based on the state of the PNC to which the ECU 200 belongs, the determination unit 121 determines whether or not the ECU 200 is in the sleep state. That is, depending on whether the PNC is in the operating state or the stopped state, the determination unit 121 determines whether or not the ECU 200 is in the sleep state. Further specifically, when a specific PNC is in the operating state, the determination unit 121 determines that the ECU 200 belonging to the PNC is in the active state. When a specific PNC is in the stopped state, the determination unit 121 determines that the ECU 200 belonging to the PNC is in the sleep state.

In a specific example, when the relay ECU 100 belongs to a specific PNC, the determination unit 121 determines, based on state information of the PNC retained by the relay ECU 100, whether or not the ECU 200 is in the sleep state.

In the example in FIG. 4, the relay ECU 100 belongs to the PNC 1. Therefore, the relay ECU 100 retains state information indicating the state (operating state or stopped state) of the PNC 1 as described above. Based on the state information retained by the relay ECU 100, the determination unit 121 determines the states of the ECUs 200A, 200C belonging to the PNC 1. That is, when the PNC 1 is in the operating state, the determination unit 121 determines that the ECUs 200A, 200C are in the active state. When the PNC 1 is in the stopped state, the determination unit 121 determines that the ECUs 200A, 200C are in the sleep state.

With reference back to FIG. 8, in another specific example, when the relay ECU 100 does not belong to a specific PNC, the determination unit 121 determines, based on the state of the PNC designated in the NM message, whether or not the ECU 200 is in the sleep state. That is, based on whether “requested (operating state)” is designated or “released (stopped state)” is designated for a specific PNC in the NM message, the determination unit 121 determines whether the ECU 200 belonging to the PNC is in the active state or in the sleep state.

Further specifically, when “requested” is designated for a specific PNC in the NM message, the determination unit 121 determines that the ECU 200 belonging to the PNC is in the active state. When an NM message in which “requested” is designated for a specific PNC has not been received for a certain period or more, the determination unit 121 determines that the ECU 200 belonging to the PNC is in the sleep state.

In the example in FIG. 4, the relay ECU 100 belongs to the PNC 2. The determination unit 121 refers to the state designated for the PNC 2 in the NM message, and determines, based on this state, the states of the ECUs 200A, 200B, 200D belonging to the PNC 2. That is, when “requested” is designated for the PNC 2 in the NM message, the determination unit 121 determines that the ECUs 200A, 200B, 200D are in the active state. When an NM message in which “requested” is designated for the PNC 2 has not been received for a certain period or more, the determination unit 121 determines that the ECUs 200A, 200B, 200D are in the sleep state.

With reference back to FIG. 8, when the ECU 200 belongs to the PNC 1 and the PNC 2, for example, the determination unit 121 determines, based on the state of the PNC 1 and the state of the PNC 2, whether or not the ECU 200 is in the sleep state. Specifically, when at least one of the PNC 1 and the PNC 2 is in the operating state, the determination unit 121 determines that the ECU 200 belonging to both the PNC 1 and the PNC 2 is in the active state. When both the PNC 1 and the PNC 2 are in the stopped state, the determination unit 121 determines that the ECU 200 belonging to both the PNC 1 and the PNC 2 is in the sleep state.

In the example in FIG. 4, the ECU 200A belongs to both the PNC 1 and the PNC 2. When at least one of the PNC 1 and the PNC 2 is in the active state, the determination unit 121 determines that the ECU 200A is in the active state. When both the PNC 1 and the PNC 2 are in the stopped state, the determination unit 121 determines that the ECU 200A is in the sleep state.

With reference back to FIG. 8, for example, the determination unit 121 identifies the PNC to which the ECU 200 belongs, based on the cluster table 108. Based on the state of the identified PNC, the determination unit 121 determines whether or not the ECU 200 is in the sleep state. Specifically, the determination unit 121 refers to the cluster table 108 shown in FIG. 4 to identify that the ECU 200A belongs to the PNC 1 and the PNC 2. Similarly, the determination unit 121 refers to the cluster table 108 to identify that the ECU 200B belongs to the PNC 2. The determination unit 121 refers to the cluster table 108 to identify that the ECU 200C belongs to the PNC 1. The determination unit 121 refers to the cluster table 108 to identify that the ECU 200D belongs to the PNC 2.

Here, the relay ECU 100 belongs to the PNC 1. When the PNC 1 is in the stopped state, that is, when an NM message in which “requested” is designated for the PNC 1 has not been received for a certain period or more, the ECU 200C belonging to the PNC 1 is in the sleep state. Meanwhile, even if the PNC 1 is in the stopped state, the relay ECU 100 does not go to sleep and maintains the active state. Accordingly, it is possible to avoid a situation where an abnormality in the ECU 200 cannot be detected due to sleeping of the relay ECU 100.

When the ECU 200 is in the sleep state, the control unit 122 disables detection of an abnormality performed by the abnormality detection unit 120. Specifically, in a case where an abnormality detection function regarding one ECU 200 (hereinafter, the ECU to be focused on will also be referred to as “target ECU”) is in an enabled state, if the target ECU 200 is in the sleep state, the control unit 122 disables the abnormality detection function regarding the target ECU 200. In a case where the abnormality detection function regarding the target ECU 200 is in a disabled state, if the target ECU 200 is in the active state, the control unit 122 enables the abnormality detection function regarding the target ECU 200.

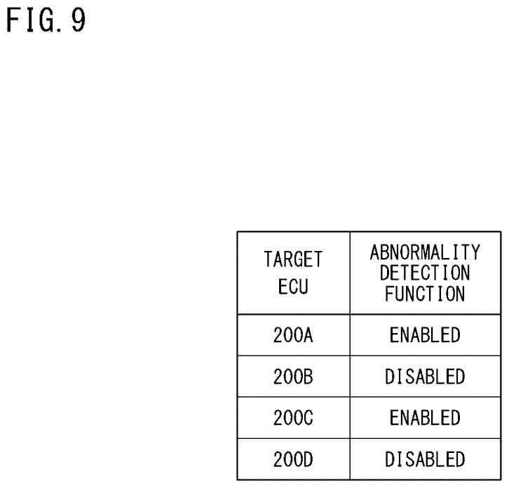

FIG. 9 is a diagram for describing disabling of the abnormality detection function. For example, a case where the abnormality detection functions regarding the ECUs 200A, 200B, 200C, 200D are all in an enabled state is considered. Here, when the PNC 2 has entered the stopped state, the ECUs 200B and 200D belonging to the PNC 2 go to sleep. Therefore, the determination unit 121 determines that the ECUs 200B and 200D are in the sleep state.

The control unit 122 disables the abnormality detection function regarding the ECU 200B. Similarly, the control unit 122 disables the abnormality detection function regarding the ECU 200D. Accordingly, erroneous detection of abnormalities in the ECUs 200B and 200D is avoided.

Here, when the PNC 2 has entered the operating state, the ECUs 200B and 200D belonging to the PNC 2 wake up. Therefore, the determination unit 121 determines that the ECUs 200B and 200D are in the active state.

The control unit 122 enables the abnormality detection function regarding the ECU 200B. Similarly, the control unit 122 enables the abnormality detection function regarding the ECU 200D. Accordingly, detection of an abnormality in the ECUs 200B and 200D is resumed.

### 1-7. Operation of Relay ECU

Next, operation of the relay ECU 100 according to the first embodiment will be described.

The processor 101 can execute an abnormality detection disabling process and an abnormality detection enabling process as below, based on the control program 107.

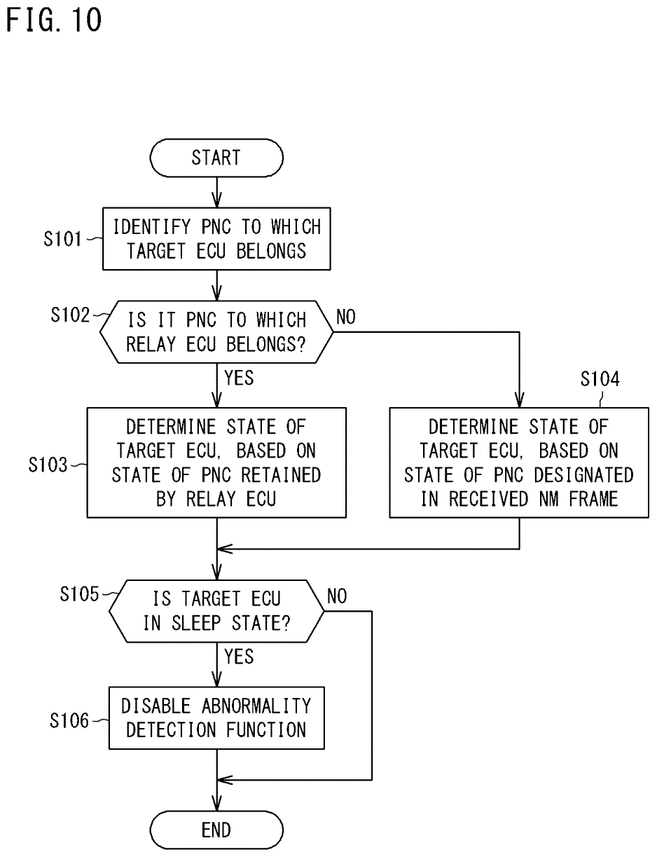

FIG. 10 is a flowchart showing an example of the abnormality detection disabling process performed by the relay ECU according to the first embodiment.

The processor 101 determines each ECU 200 to be a target ECU. The abnormality detection disabling process is executed for each target ECU. Further specifically, the abnormality detection disabling process is executed for a target ECU for which the abnormality detection function is in an enabled state. That is, the abnormality detection disabling processes for the target ECUs for which the abnormality detection functions are in an enabled state are executed in parallel.

The processor 101 refers to the cluster table 108 and identifies the PNC to which the target ECU 200 belongs (step S101).

Next, the processor 101 determines whether or not the relay ECU 100 belongs to the identified PNC (step S102).

When the relay ECU 100 belongs to the identified PNC (YES in step S102), the processor 101 determines the state of the target ECU 200, based on the state of the PNC retained by the relay ECU 100 (step S103). That is, when the state of the PNC retained by the relay ECU 100 is the operating state, the processor 101 determines that the target ECU 200 is in the active state. Meanwhile, when the state of the PNC retained by the relay ECU 100 is the stopped state, the processor 101 determines that the target ECU 200 is in the sleep state.

When the relay ECU 100 does not belong to the identified PNC (NO in step S102), the processor 101 refers to the NM message received by the relay ECU 100. Based on the state of the PNC designated in the NM message, the processor 101 determines the state of the target ECU 200 (step S104). That is, when “requested” is designated for the identified PNC in the NM message received by the relay ECU 100, the processor 101 determines that the target ECU 200 is in the active state. Meanwhile, when an NM message in which “requested” is designated for the identified PNC has not been received by the relay ECU 100 for a certain period or more, the processor 101 determines that the target ECU 200 is in the sleep state.

The processor 101 determines whether the target ECU 200 has been determined to be in the sleep state or in the active state in step S103 or S104 (step S105).

When the target ECU 200 has been determined to be in the active state (NO in step S105), the abnormality detection disabling process ends. That is, in this case, the enabled state of the abnormality detection function regarding the target ECU 200 is maintained.

When the target ECU 200 has been determined to be in the sleep state (YES in step S105), the processor 101 disables the abnormality detection function regarding the target ECU 200 (step S106). Then, the abnormality detection disabling process ends.

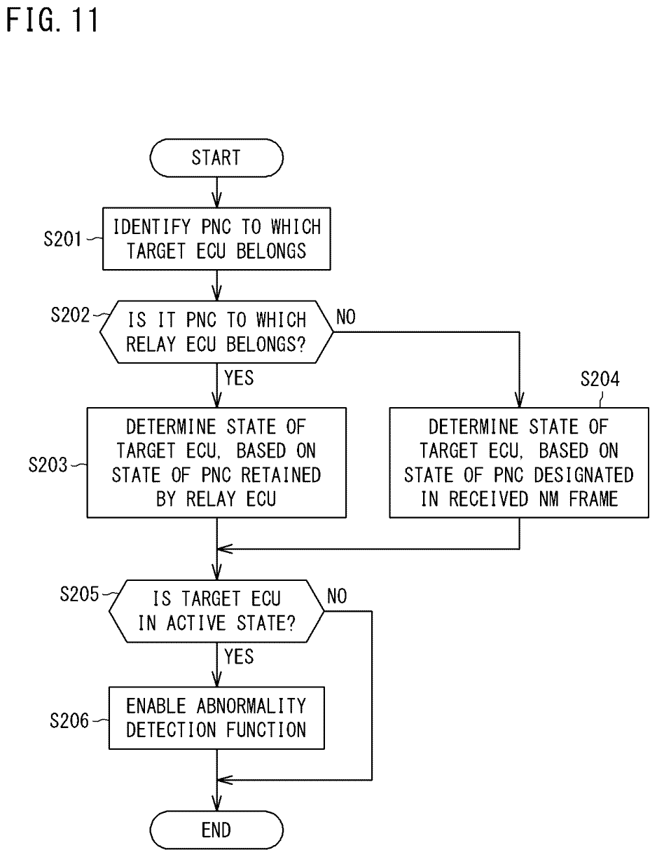

FIG. 11 is a flowchart showing an example of the abnormality detection enabling process performed by the relay ECU according to the first embodiment.

The abnormality detection enabling process is executed for each target ECU. Further specifically, the abnormality detection enabling process is executed for a target ECU for which the abnormality detection function is in a disabled state. That is, the abnormality detection enabling processes for the target ECUs for which the abnormality detection functions are in a disabled state are executed in parallel.

The processor 101 refers to the cluster table 108 and identifies the PNC to which the target ECU 200 belongs (step S201).

Next, the processor 101 determines whether or not the relay ECU 100 belongs to the identified PNC (step S202).

When the relay ECU 100 belongs to the identified PNC (YES in step S202), the processor 101 determines the state of the target ECU 200, based on the state of the PNC retained by the relay ECU 100 (step S203). Step S203 is the same process as step S103.

When the relay ECU 100 does not belong to the identified PNC (NO in step S202), the processor 101 refers to the NM message received by the relay ECU 100. Based on the state of the PNC designated in the NM message, the processor 101 determines the state of the target ECU 200 (step S204). Step S204 is the same process as step S104.

The processor 101 determines whether the target ECU 200 has been determined to be in the sleep state or in the active state in step S203 or S204 (step S205).

When the target ECU 200 has been determined to be in the sleep state (NO in step S205), the abnormality detection enabling process ends. That is, in this case, the disabled state of the abnormality detection function regarding the target ECU 200 is maintained.

When the target ECU 200 has been determined to be in the active state (YES in step S205), the processor 101 enables the abnormality detection function regarding the target ECU 200 (step S206). Then, the abnormality detection enabling process ends.

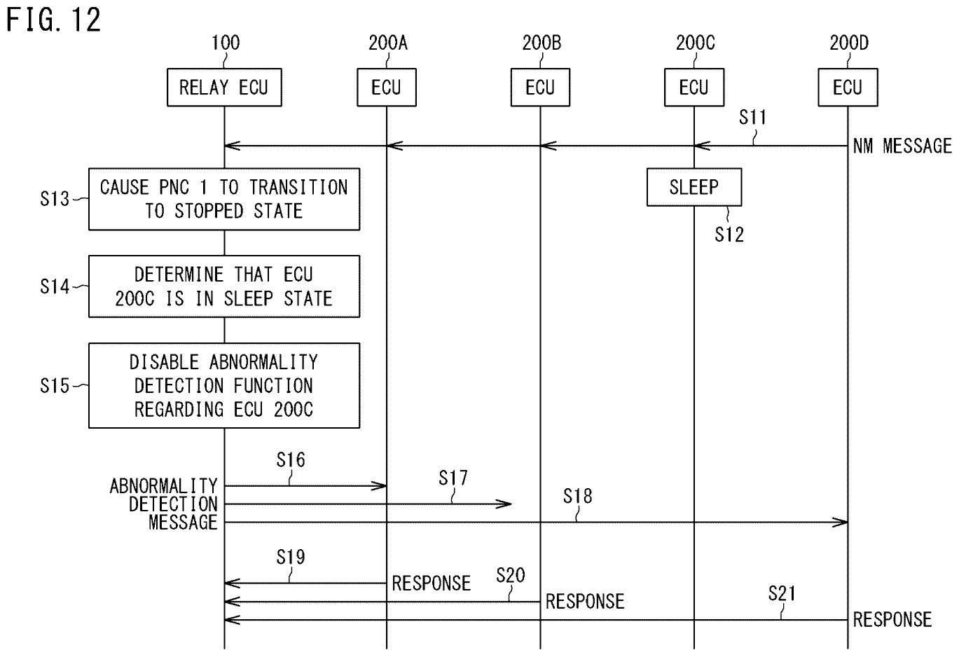

FIG. 12 is a sequence diagram showing a first example of the procedure of disabling of abnormality detection in the in-vehicle system according to the first embodiment.

FIG. 12 shows an example in which, in a case where the ECUs 200A, 200B, 200C, 200D are in the active state, the ECU 200D transmits an NM message in which “requested” is designated for the PNC 2. In this example, an NM message in which “requested” is designated for the PNC 1 is not transmitted from any of the ECUs 200.

The ECU 200D transmits an NM message in which “requested” is designated for the PNC 2 (step S11). The NM message is a broadcast message and is transmitted to each of the relay ECU 100 and the ECUs 200A, 200B, 200C.

The ECUs 200A, 200B belonging to the PNC 2 maintain the active state since “requested” is designated for the PNC 2 in the received NM message. The ECU 200D being the transmission source of the NM message also maintains the active state.

In the NM message transmitted from the ECU 200D, “released” is designated for the PNC 1. The ECU 200C belonging to the PNC 1 does not receive an NM message in which “requested” is designated for the PNC 1, for a certain period or more. Therefore, the ECU 200C goes to sleep (step S12).

Since the relay ECU 100 also belongs to the PNC 1, the relay ECU 100 is, originally, the target for sleep. However, since the relay ECU 100 needs to execute the abnormality detection disabling process, the relay ECU 100 maintains the active state regardless of the PN information in the NM message.

The relay ECU 100 does not receive an NM message in which “requested” is designated for the PNC 1, for a certain period or more. Therefore, the processor 101 of the relay ECU 100 determines that the state of the PNC 1 is “stopped state”, and causes the retained state information of the PNC 1 to transition from “operating state” to “stopped state” (step S13).

The processor 101 refers to the cluster table 108 and identifies that the ECU belonging to the PNC 1 is the ECU 200C. The processor 101 determines that the state of the identified ECU 200C is “sleep state” (step S14).

The processor 101 disables the abnormality detection function regarding the ECU 200C determined to be in the sleep state (step S15).

The abnormality detection function regarding the ECUs 200A, 200B, 200D in the active state is in an enabled state. Therefore, the relay ECU 100 transmits an abnormality detection message to the ECUs 200A, 200B, 200D (steps S16, S17, S18). The ECUs 200A, 200B, 200D transmit a response to the abnormality detection message, to the relay ECU 100 (steps S19, S20, S21).

Meanwhile, the relay ECU 100 does not transmit an abnormality detection message to the ECU 200C for which the abnormality detection function is in a disabled state. Accordingly, erroneous detection of an abnormality in the ECU 200C can be avoided.

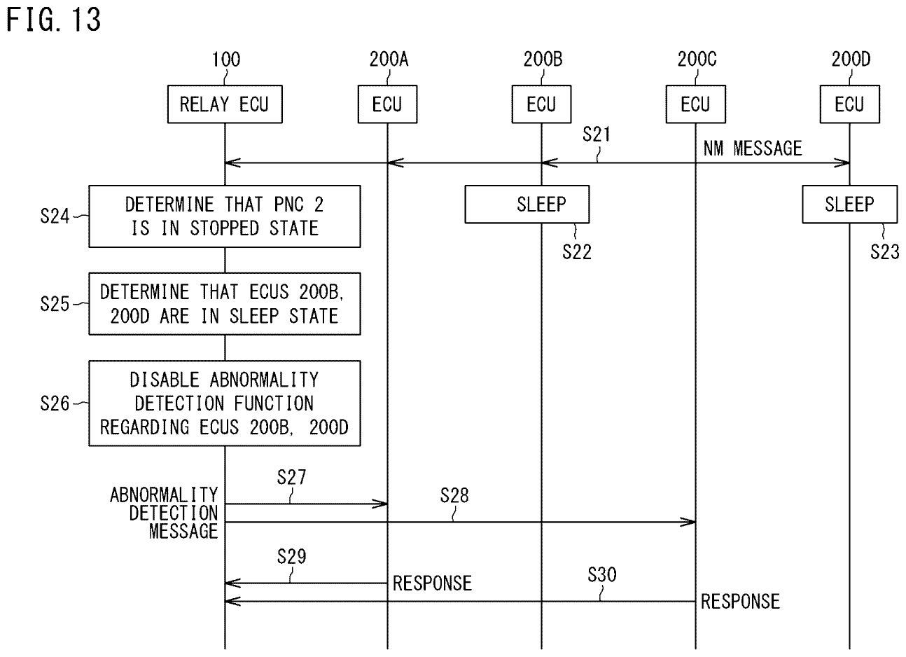

FIG. 13 is a sequence diagram showing a second example of the procedure of disabling of abnormality detection in the in-vehicle system according to the first embodiment.

FIG. 13 shows an example in which, in a case where the ECUs 200A, 200B, 200C, 200D are in the active state, the ECU 200C transmits an NM message in which “requested” is designated for the PNC 1. In this example, an NM message in which “requested” is designated for the PNC 2 is not transmitted from any of the ECUs 200.

The ECU 200C transmits an NM message in which “requested” is designated for the PNC 1 (step S21). The NM message is a broadcast message and is transmitted to each of the relay ECU 100 and the ECU 200A, 200B, 200D.

The ECU 200A belonging to the PNC 1 maintains the active state since “requested” is designated for the PNC 1 in the received NM message. The ECU 200C being the transmission source of the NM message also maintains the active state.

The relay ECU 100 also belongs to the PNC 1. However, since the relay ECU 100 needs to execute the abnormality detection disabling process, the relay ECU 100 maintains the active state regardless of the PN information in the NM message.

In the NM message transmitted from the ECU 200C, “released” is designated for the PNC 2. The ECUs 200B, 200D belonging to the PNC 2 does not receive an NM message in which “requested” is designated for the PNC 2, for a certain period or more. Therefore, the ECUs 200B, 200D go to sleep (steps S22, S23).

The relay ECU 100 does not receive an NM message in which “requested” is designated for the PNC 2, for a certain period or more. Therefore, the processor 101 of the relay ECU 100 determines that the state of the PNC 2 is “stopped state” (step S24).

The processor 101 refers to the cluster table 108 and identifies that the ECU belonging to the PNC 2 is the ECUs 200B, 200D. The processor 101 determines that the state of the identified ECUs 200B, 200D is “sleep state” (step S25).

The processor 101 disables the abnormality detection function regarding the ECUs 200B, 200D determined to be in the sleep state (step S26).

The abnormality detection function regarding the ECUs 200A, 200C in the active state is in an enabled state. Therefore, the relay ECU 100 transmits an abnormality detection message to the ECUs 200A, 200C (steps S27, S28). The ECUs 200A, 200C transmit a response to the abnormality detection message, to the relay ECU 100 (steps S29, S30).

Meanwhile, the relay ECU 100 does not transmit an abnormality detection message to the ECUs 200B, 200D for which the abnormality detection function is in a disabled state. Accordingly, erroneous detection of abnormalities in the ECUs 200B, 200D can be avoided.

### 2. Second Embodiment

In the first embodiment above, the relay ECU 100 is an Ethernet switch. However, the relay ECU is not limited to an Ethernet switch. For example, the relay ECU may be a relay device that relays a CAN (Controller Area Network) message.

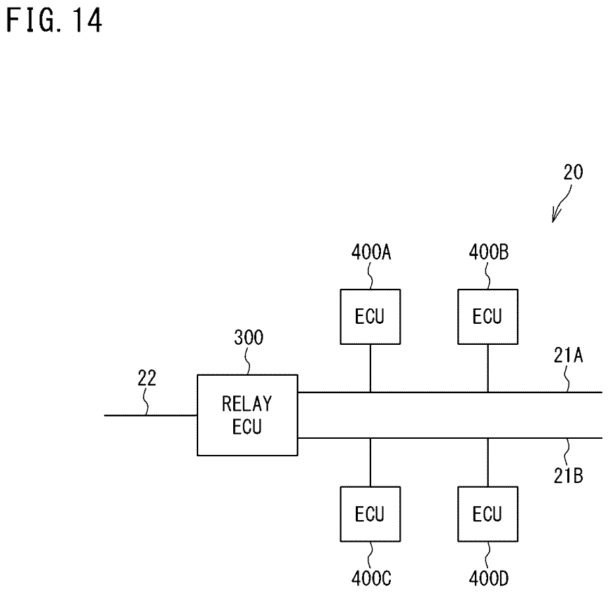

FIG. 14 is a block diagram showing an example of a configuration of an in-vehicle system according to a second embodiment.

An in-vehicle system 20 includes a relay ECU 300 and ECUs 400A, 400B, 400C, 400D. The in-vehicle system 20 is an in-vehicle network composed of the relay ECU 300, the ECUs 400A, 400B, 400C, 400D, and communication buses 21A, 21B connecting them. That is, the in-vehicle system 20 is a CAN network having a bus-type network topology.

Specifically, the ECUs 400A, 400B are connected to the communication bus 21A. The ECUs 400C, 400D are connected to the communication bus 21B. The relay ECU 300 is connected to each of the communication buses 21A, 21B. From the relay ECU 300, a communication bus 22 extends. The relay ECU 300 is connected to an in-vehicle device (e.g., a relay ECU or an ECU) (not shown) through the communication bus 22.

Each of the relay ECU 300 and the ECUs 400A, 400B, 400C, 400D includes a communication I/F conforming to CAN. The relay ECU 300 relays communication between the ECUs 400A, 400B and the ECUs 400C, 400D. That is, the relay ECU 300 relays a CAN frame (message) between the ECUs 400A, 400B and the ECUs 400C, 400D.

The relay ECU 300 and the ECUs 400A, 400B, 400C, 400D can transmit and receive an NM message for a partial network. The NM message is a CAN frame that is periodically transmitted.

In the present modification, the relay ECU 300 transmits a CAN message, which is an abnormality detection message, to each of the communication buses 21A, 21B. Upon receiving the abnormality detection message, the ECUs 400A, 400B, 400C, 400D send out a response message to the communication buses 21A, 21B. For example, the response message includes the CAN ID of the ECU 400A, 400B, 400C, 400D being the transmission source. The relay ECU 300 receives the response message, thereby determining that the ECU 400A, 400B, 400C, 400D being the transmission source identified by the CAN ID is normal. When an ECU that does not transmit a response message is present among the ECUs 400A, 400B, 400C, 400D, the relay ECU 300 detects an abnormality in the ECU that does not transmit a response message.

The relay ECU 300 determines whether or not each of the ECUs 400A, 400B, 400C, 400D is in the sleep state. The relay ECU 300 disables the abnormality detection function regarding the ECU determined to be in the sleep state. Disabling and enabling of the abnormality detection function are the same as those in the first embodiment described above.

### 3. Modification

In the first embodiment and the second embodiment described above, the relay ECU 100, 300 that relays communication between the ECUs has the abnormality detection function, and when an ECU is in the sleep state, disables the abnormality detection function regarding the ECU in the sleep state. However, the present disclosure is not limited thereto. For example, an ECU connected to one communication bus may have the abnormality detection function regarding another ECU connected to the same communication bus, and when the ECU connected to the same communication bus is in the sleep state, may disable the abnormality detection function regarding the ECU in the sleep state.

For example, a case where the ECU 200B is the device (in-vehicle control device) having the abnormality detection function is considered. The ECU 200B can detect an abnormality in the ECU 200A connected to the same communication bus 21A. Here, with reference to FIG. 4, the ECU 200B belongs to the PNC 2 and does not belong to the PNC 1. Similarly, the ECU 200D belongs to the PNC 2 and does not belong to the PNC 1. When the PNC 2 is in the stopped state, that is, when the ECU 200D does not receive an NM message in which “requested” is designated for the PNC 2, for certain period or more, the ECU 200D is in the sleep state. Meanwhile, even if the PNC 2 is in the stopped state, the ECU 200B does not go to sleep and maintains the active state. Accordingly, it is possible to avoid a situation where an abnormality in the ECU 200A cannot be detected due to sleeping of the ECU 200B. It is noted that not only the ECU 200B can serve as an in-vehicle control device but also the ECUs 200A, 200C, 200D can serve as an in-vehicle control device that has the abnormality detection function. In a case where the ECU 200A, 200B, 200C, 200D is the in-vehicle control device, the relay ECU 300 can be an in-vehicle device that does not have the abnormality detection function.

In the first embodiment, abnormality detection in an in-vehicle network conforming to Ethernet and disabling of the abnormality detection have been described. In the second embodiment, abnormality detection in an in-vehicle network conforming to CAN and disabling of the abnormality detection have been described. However, the present disclosure is not limited thereto. As long as the communication protocol is compatible with the partial network, a communication protocol other than Ethernet and CAN may be used. For example, in an in-vehicle network conforming to FlexRay, abnormality detection of an ECU and disabling of the abnormality detection may be realized.

### 4. Supplementary Note

The above embodiments are merely illustrative in all aspects and are not restrictive. The scope of the present disclosure is defined by the scope of the claims rather than the embodiments described above, and is intended to include meaning equivalent to the scope of the claims and all modifications within the scope.

1. An in-vehicle control device connected through a network to an in-vehicle device switchable between an active state and a sleep state, the in-vehicle control device comprising:
an abnormality detection unit configured to detect an abnormality in the in-vehicle device;
a determination unit configured to determine whether or not the in-vehicle device is in the sleep state, based on a state of a cluster to which the in-vehicle device belongs; and
a control unit configured to, when the in-vehicle device is in the sleep state, disable detection of an abnormality performed by the abnormality detection unit.

2. The in-vehicle control device according to claim 1, wherein
when the in-vehicle control device belongs to the cluster, the determination unit determines whether or not the in-vehicle device is in the sleep state, based on the state of the cluster retained by the in-vehicle control device.

3. The in-vehicle control device according to claim 1, wherein
when the in-vehicle control device does not belong to the cluster, the determination unit determines whether or not the in-vehicle device is in the sleep state, based on the state of the cluster designated in a control message transmitted through the network in order to control the cluster.

4. The in-vehicle control device according to claim 1, wherein
when the in-vehicle device belongs to a first cluster and a second cluster, the determination unit determines whether or not the in-vehicle device is in the sleep state, based on a state of the first cluster and a state of the second cluster.

5. The in-vehicle control device according claim 1, wherein
the determination unit identifies a cluster to which the in-vehicle device belongs, based on a table indicating a correspondence relationship between a cluster and an in-vehicle device, and determines whether or not the in-vehicle device is in the sleep state, based on a state of the cluster having been identified.

6. The in-vehicle control device according claim 1, wherein
the state of the cluster includes an operating state and a stopped state, and
when the state of the cluster is the stopped state, the determination unit determines that the in-vehicle device is in the sleep state.

7. The in-vehicle control device according claim 1, wherein
the abnormality detection unit detects an abnormality in the in-vehicle device, based on a communication state of the in-vehicle device through the network.

8. The in-vehicle control device according claim 1, wherein
when the in-vehicle control device belongs to the cluster and the cluster is in the stopped state, the in-vehicle control device maintains an active state.

9. A control method to be used by an in-vehicle control device connected through a network to an in-vehicle device switchable between an active state and a sleep state, the control method comprising:
a step of determining whether or not the in-vehicle device is in the sleep state, based on a state of a cluster to which the in-vehicle device belongs; and
a step of disabling an abnormality detection function of detecting an abnormality in the in-vehicle device, when the in-vehicle device is in the sleep state.

10. A non-transitory computer-readable storage medium having, stored therein, a control program to be executed by an in-vehicle control device connected through a network to an in-vehicle device switchable between an active state and a sleep state, the control program causing a computer to execute:
a step of determining whether or not the in-vehicle device is in the sleep state, based on a state of a cluster to which the in-vehicle device belongs; and
a step of disabling an abnormality detection function of detecting an abnormality in the in-vehicle device, when the in-vehicle device is in the sleep state.
